(19) United States
(12) Patent Application Publication
(10) Pub. No.: US 2020/0053042 A1
(43) Pub. Date: Feb. 13, 2020

(54) SERVICE METHOD AND SYSTEM FOR TOPIC NETWORK HAVING TREE STRUCTURE OF HASHTAG

(71) Applicant: SNIPPOD INC., Seongnam-si, Gyeonggi-do (KR)

(72) Inventor: Seong Gyu LEE, Yongin-si, Gyeonggi-do (KR)

(73) Assignee: SNIPPOD INC., Seongnam-si, Gyeonggi-do (KR)

(21) Appl. No.: 16/339,748

(22) PCT Filed: Sep. 29, 2017
(86) PCT No.: PCT/KR2017/011017

§ 371 Date: Apr. 5, 2019

(30) Foreign Application Priority Data
Oct. 11, 2016 (KR) 10-2016-0131418

(51) Int. Cl. H04L 12/58; G06F 16/9535; G06Q 50/00; G06F 16/2457; G06F 16/901

(52) U.S. Cl. CPC H04L 51/32; G06F 16/9535; G06F 16/9027; G06F 16/24578; G06Q 50/01

(57) ABSTRACT

A service method and system for a topic network having a tree structure of a hashtag is provided. The method includes generating first information at a first node of the topic network based on a user input and exposing the first information, generated at the first node, at an upper node having a defined connection relation with the first node.

### TECHNICAL FIELD

Embodiments of the inventive concept described herein relate to technologies of providing a topic network service and more particularly, relate to a service method and system for a topic network to share per-topic information based on a hashtag on a topic network having a tree structure of the hashtag and select information a user prefers.

### BACKGROUND ART

Today, end users generate a vast amount of content including content of image and video formats and relay content to various media networks (e.g., a content storage network, a cloud computing infra, a social network, and the like) of various user devices (e.g., desktops, palmtops, e-readers, handhelds, and similar devices) via the various user devices.

### DETAILED DESCRIPTION OF THE INVENTION

### Technical Problem

Embodiments of the inventive concept provide a service method and system for a topic network to group a large amount of information, which exist on the web, for each topic and easily provide a topic a user has an interest in.

### Technical Solution

According to an exemplary embodiment, a service method for a topic network may include generating first information at a first node of the topic network based on a user input and exposing the first information, generated at the first node, at an upper node having a defined connection relation with the first node.

The exposing at the upper node may include, when the exposing at the upper node is set by a user when the first information is generated, exposing the first information at an upper node of the first node.

The exposing at the upper node may include, when the exposing at the upper node is preset with respect to the first node, exposing the first information at an upper node of the first node.

The exposing at the upper node may include, when the first node is tagged to a plurality of upper nodes, exposing the first information at each of the plurality of upper nodes.

The method may further include calculating a ranking score of each of information in consideration of popularity including at least one of upvoting, downvoting, a follower, a comment, or an evaluation score by others, a time when each of exposed information is generated, and a current time, with respect to the information exposed at each node of the topic network.

The calculating of the ranking score may include calculating the ranking score of each of the information in each of the plurality of ranking algorithms by reflecting a weight differently set for each of a plurality of predetermined ranking algorithms in at least one of the popularity or a difference between the current time and the time when each of the exposed information is generated.

The exposing at the upper node may include identifying an upper node having a defined connection relation with the first node, based on a correction between a hashtag of the first node or the first information and a hashtag of each node of the topic network having the tree structure and exposing the first information at the identified upper node.

According to an exemplary embodiment, a service method for a topic network may include defining a relation between a first node in the topic network and first information to be generated, based on a user input and, when the relation between the first node and the first information is defined, exposing the first information at an upper node having a defined connection relation with the first node.

According to an exemplary embodiment, a service system for a topic network may include a generator configured to generate first information at a first node of the topic network based on a user input and a controller configured to expose the first information, generated at the first node, at an upper node having a defined connection relation with the first node.

The controller may be configured to, when the exposing at the upper node is set by a user when the first information is generated, expose the first information at an upper node of the first node.

The controller may be configured to, when the exposing at the upper node is preset with respect to the first node, expose the first information at an upper node of the first node.

The controller may be configured to, when the first node is tagged to a plurality of upper nodes, expose the first information at each of the plurality of upper nodes.

The system may further include a calculator configured to calculate a ranking score of each of information in consideration of popularity including at least one of upvoting, downvoting, a follower, a comment, or an evaluation score by others, a time when each of exposed information is generated, and a current time, with respect to the information exposed at each node of the topic network.

The calculator may be configured to calculate the ranking score of each of the information in each of the plurality of ranking algorithms by reflecting a weight differently set for each of a plurality of predetermined ranking algorithms in at least one of the popularity or a difference between the current time and the time when each of the exposed information is generated.

The controller may be configured to identify an upper node having a defined connection relation with the first node, based on a correction between a hashtag of the first node or the first information and a hashtag of each node of the topic network having the tree structure and expose the first information at the identified upper node.

### Advantageous Effects of the Invention

According to embodiments of the inventive concept, information generated at a lower node may be provided at an upper node and a large amount of information which exist on the web may be grouped for each topic (or each subject) to easily provide a subject a user has an interest in, by exposing information of the lower node at the upper node of which connection relation is defined through hashtags in a topic network service implemented based on a tree structure of the hashtags.

According to embodiments of the inventive concept, information about an interesting subject may be easily provided by connecting and providing subjects associated with separate subjects.

According to embodiments of the inventive concept, information the user wants may be easily retrieved by providing information provided for each subject in a sort mode the user wants, by means of a plurality of ranking algorithms arranged by different weights.

### DESCRIPTION OF THE DRAWINGS

FIG. 1 is an operational flowchart of a service method for a topic network according to an embodiment of the inventive concept;

FIG. 2 is an operational flowchart of an embodiment for step S140 shown in FIG. 1,

FIG. 3 is a drawing illustrating a relation between topics;

FIG. 4 is a drawing illustrating a relation between a topic and a snip and between snips;

FIG. 5 is a drawing illustrating multi-tagging;

FIG. 6 is a drawing illustrating generating a topic or snip;

FIG. 7 is a drawing illustrating a topic network service based on a tree structure of a hashtag;

FIG. 8 is a drawing illustrating calculating a ranking score for each of sort modes; and

FIG. 9 is a drawing illustrating a configuration of a service system for a topic network according to an embodiment of the inventive concept.

### BEST MODE

Hereinafter, a description will be given in detail of embodiments with reference to the accompanying drawings. However, the inventive concept is restricted or limited to embodiments of the inventive concept. Further, like reference numerals shown in each drawing indicates like members.

Embodiments of the inventive concept may be the gist of exposing information of a lower node at an upper node of which connection relation is defined through hashtags in a service for a topic network configured based on a tree structure of the hashtags to provide information generated at the lower node at the upper node.

A topic network service in the inventive concept may be a service of sorting information about the world for each subject (or each topic) and allowing everybody to easily receive information he or she needs and may refer to a per-subject information network service, in which a plurality of related information are connected with each other and are arranged according to who and when in any situation, for allowing everybody to easily have valuable information. As described above, such a topic network service may group a large amount of information, which exist on the web, for each subject and may allow everybody to easily view a subject he or she has an interest in.

Herein, in the topic network service of the inventive concept, a connection relation between topic nodes (or pod nodes) may be defined by means of hashtags and a connection relation between a topic node and information (or content) node (or a snip node) may be defined by means of hashtags.

Hereinafter, a topic node or a pod node in a detailed description of the inventive concept may be a category classified for each subject. A snip node may be content or information generated at a topic node. A snip may be a kind of medium which implies content. A user may complete the snip through a process of writing content in the snip and connecting the written content with another content.

Herein, the snip may have only main content text content has for itself, but it may include a link (including both of an external link and an internal link), an image, a video, and the like. In the detailed description, information generated at a topic node and the snip may be used as the same meaning.

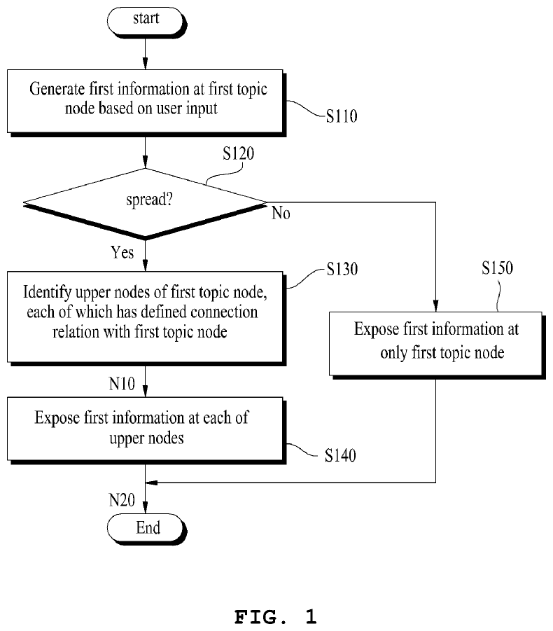

FIG. 1 is an operational flowchart of a service method for a topic network according to an embodiment of the inventive concept. The method according to the inventive concept may be performed in a system or server which provides a topic network service and may be for a service method for a topic network in which a connection relation between nodes including a topic node and a snip node has a tree structure based on a hashtag.

Referring to FIG. 1, the service method for the topic network according to an embodiment of the inventive concept may generate a snip or information a user wants to provide, that is, first information, at a topic node or a subject the user has an interest in, that is, a first topic node, based on a user input (S110).

Herein, the snip or information generated in step S110 may be tagged to only one topic node or snip node, and may be multi-tagged to a plurality of predetermined topic nodes.

When the first information is generated at the first topic node in step S110, it may be determined whether the generated first information is set to be exposed at an upper node of the first topic node, that is, whether a spread function is set. When it is determined that the spread function is set, upper nodes of the first topic node, each of which has a defined connection relation with the first topic node, may be identified and the first information may be controlled to be exposed at each of the identified upper nodes (S120 to S140).

Herein, step S120 is described as, but not limited to, determining whether the spread function for the first information is set. Irrespective of whether the spread function of the first information is set, it may be determined whether a spread function of the first topic node is set to determine whether the first information is exposed at the upper node.

At this time, step S130 may verify the upper node having the defined connection relation with the first topic node, based on a correlation between a hashtag of the first topic node and a hashtag of each of topic nodes configuring a topic network.

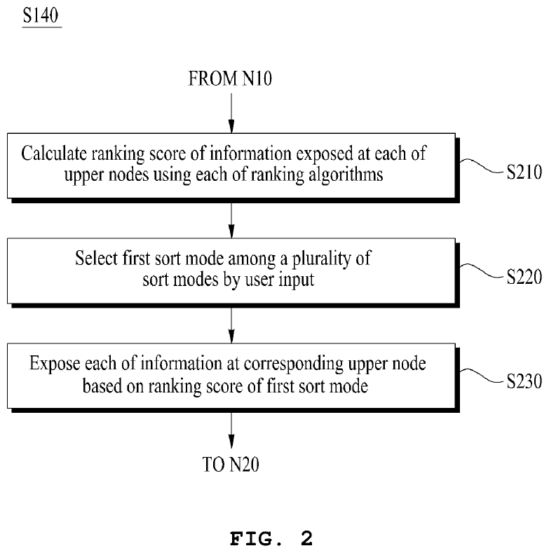

FIG. 1 describes, but is not limited to, the exposure of the first information generated by the user. In a topic network based on a tree structure of a hashtag, information of the topic node may be exposed at the upper node. A description will be given of step S140 based on such details with reference to FIG. 2.

FIG. 2 is an operational flowchart of an embodiment for step S140 shown in FIG. 1. Step S140 may calculate a ranking score of each of information using each of a plurality of predefined ranking algorithms with respect to the information exposed at each of upper nodes (S210).

Herein, step S210 may calculate ranking scores of information using the plurality of ranking algorithms in real time or on a predetermined time basis and may calculate a ranking score in each of the ranking algorithms based on popularity of each of the information, a current time, and a time when each of the information is generated.

At this time, step S210 may calculate a ranking score of each of the information in consideration of popularity, including at least one of upvoting, downvoting, a follower, a comment, or an evaluation score by others, a time when each of the exposed information is generated, and a current time. In detail, step S210 may reflect a weight differently set for each of the plurality of ranking algorithms in at least one of the popularity or a difference between the current time and the time when the information is generated to calculate a ranking score for each of the information in each of the plurality of ranking algorithms.

Herein, a score by the upvoting may correspond to a maximum value capable of being added, and a score by the downvoting may correspond to a minimum value capable of being added.

Of course, the weight may be set differently for each topic, and such a weight may be set differently according to the nature of a topic. For example, when the corresponding topic is a topic of which time is important, the weight may be set to become more important in order of time. When the corresponding topic is a topic of which importance is more important, the weight may be set to become more important in importance.

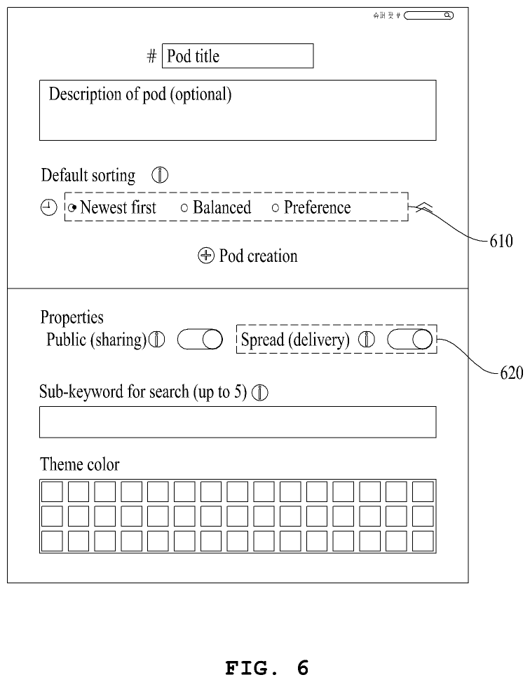

The ranking algorithm in the inventive concept may be an algorithm for each of newest first (newest based), balanced sorting, and preference order, which are sort modes shown in FIG. 6. In the newest first (newest based), a difference (time decay) between a current time and a time when information is set as the most important parameter. In the preference order, popularity evaluated by reactions of others may be set as the most important parameter.

Herein, a time decay parameter (a newest degree) timedecay_{Nx,Tc} may be represented as Equation 1 below.

$${timedecay}_{Nx , Tc} = {e}^{- \frac{{recency}_{Nx}}{{λ}_{time , Tc}}} \qquad [ Equation 1 ]$$

Herein, recency_{Nx} denotes the difference between the current time and the time when information Nx is generated, λ_{time,Tc} denotes the predetermined value, the corresponding value being differently set according to a ranking algorithm or a sort mode. As seen in Equation 1 above, the time decay parameter may be calculated using a sigmoid function.

For example, in a ranking algorithm for newest first (newest based), λ_{time,Tc} may be set to a very small value to increase a degree which does not become important as time goes on.

As such, because of using the time decay parameter as an exponential function, the inventive concept may manage time importance suitably over λ_{time,Tc}.

The weight used to calculate a ranking score in the inventive concept may be determined based on an element such as popularity of corresponding information or a time decay. The time decay may refer to a difference between a current time and a time when corresponding information is generated.

Herein, the popularity may correspond to a corresponding node score. A node score for each node (including both of a topic node and a snip node) may be calculated based on a unique point of the corresponding node (a total score according to upvoting for the corresponding node, downvoting for the corresponding node, and reactions of other users) and a value obtained by adding unique points of a lower node connected with the corresponding node. Of course, when the corresponding node is a snip node, a unique point may be calculated as a score of the corresponding node. That is, a score of the upper node may be higher than a score of the lower node.

The ranking score in the inventive concept may be calculated using the calculated score of each node and the time decay parameter. Each ranking algorithm may differently set λ_{time,Tc} configuring the time decay parameter to calculate a ranking score in each ranking algorithm. For example, a ranking algorithm for newest first (newest based) may set λ_{time,Tc} to 0.1, a raking algorithm for preference order may set λ_{time,Tc} to 100, and a ranking algorithm for balanced sorting may set λ_{time,Tc} to 5. Of course, such λ_{time,Tc} may be determined by a provider or person who provides the corresponding technology. Furthermore, λ_{time,Tc} for each of the ranking algorithms may be differently set for each topic. λ_{time,Tc} for each topic may be set by the provider which provides the corresponding technology or the user who generates the corresponding topic.

As described above, step S210 may calculate a ranking score for each of the plurality of ranking algorithms. As an example shown in FIG. 8, when snips X, Y, and Z are included in a car topic node, ranking scores X₁, X₁″, and X₁′″ for snip X may be calculated with respect to each of three ranking algorithms for a sort mode. Ranking scores Y₁, Y₁″, and Y₁′″ for snip Y may be calculated with respect to each of the three ranking algorithms. Ranking scores Z₁, Z₁″, and Z₁′″ for snip Z may be calculated with respect to each of the three ranking algorithms. When a first sort mode is selected at the car topic node, snips X, Y, and Z may be sorted and exposed using the first ranking scores X₁′, Y₁′, and Z₁′. Of course, ranking scores X₂′, X₂″, and X₂′″ for snip X may be calculated using each of the three ranking algorithms with respect to snip X exposed at a mania topic node which is an upper node of the car topic node. Rankings scores may be calculated for snips Y and Z in the same manner. Herein, a score and the like of the car topic node may be further considered at the mania topic node to calculate a ranking score for each of exposed information.

As described above, when the ranking score is calculated in each of the plurality of algorithms in step S210 and when a first sort mode for retrieving information is selected among sort modes corresponding to the plurality of ranking algorithms by a user input at a topic node a user wants, information exposed at the corresponding topic node may be exposed in the first sort mode based on the ranking score (S220, S230).

Such inventive concept may be a topic network service in which nodes have a tree structure based on a correlation or a connection relation between hashtags of each of topics. As a hashtag is set when a topic node is generated by the user or a service provider, a connection relation between topic nodes may be defined based on the hashtag.

At this time, as shown in FIG. 6, the topic node may be generated based on a user interface for generating a topic (or pod). A hashtag may be input when a topic is generated and a sorting method 610 at the corresponding topic may be set based on a user input. Exposing at an upper node may be determined by setting an item for determining to expose information of the corresponding topic at an upper topic, that is, the upper node, having a defined connection relation with the corresponding topic, that is, a spread function 620. For example, when the spread function is set to off, information of a corresponding topic node may be exposed at only a corresponding topic. When the spread function is set to on, the information of the corresponding topic node may be exposed at an upper node of the corresponding topic node. As such, default sorting which is important at a corresponding topic when the corresponding topic is generated may be set, and whether to be exposed at an upper node may be set. Because newest information is important for a topic such as Olympics, it may be preferable that the default sorting is set to newest first (newest based) when the corresponding topic is generated. It may be preferable to enable a spread function such that Olympic information is exposed at an upper node of Olympics, for example, a news node.

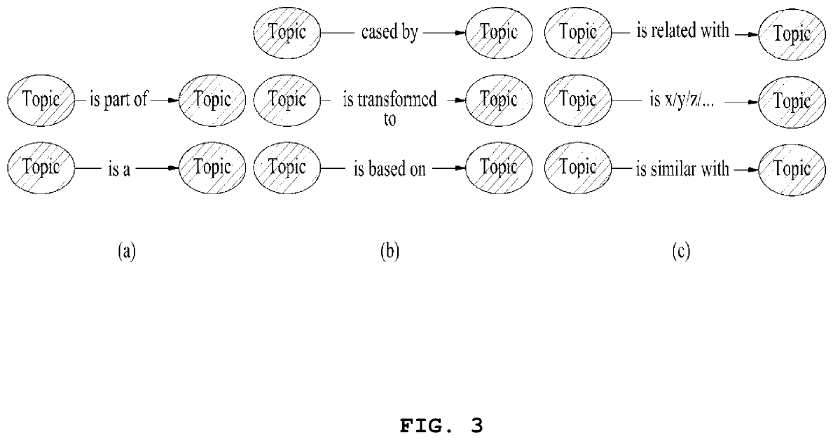

A description will be given of the definition between such topics, the definition between the topic and the snip, or the definition between the snips with reference to FIGS. 3 to 5.

FIG. 3 is a drawing illustrating a relation between topics.

FIG. 3a defines a relation between topics and defines an upper and lower relation. “A is part of B” means that topic A is limited to a lower part of topic B. For example, “tire is part of car” may mean that a tire topic is limited to a car topic and is limited to a tire of a car. Thus, the tire topic may fail to be duplicated and classified as a category of another topic. However, a grouping relation may be brought to “is a” of a topic which means all tires. “A is a B” may define a grouping relation and may mean that all As are interpreted as B.

FIG. 3b defines a relation between topics in which a change over time is reflected and illustrates a case where a new topic is generated and establishes a relation, such an influence or modification, with an old topic to clearly classify a time relation.

As shown in FIG. 3b, “A caused by B” may indicate a cause-effect relationship. A means the result of B. “A is transformed to B” may refer to a topic transformed over time. “A is based on B” may define a relation when a new topic based on the topic is generated.

FIG. 3c defines a relation of properties between topics. “is related with” may be regarded as a definition including all relations of FIGS. 3a and 3b. “is x/y/z” may mean that one topic defines a relation with various topics. “is similar with” may define am adding function when similar topics are duplicated and established or in case of speaking substantially the same subject from a different point of view.

By defining the relation between the topics with reference to FIG. 3, although a user does not explicitly define the relation an implicit relation in FIG. 3 may be automatically determined. When there is a relation, a relation between the above-mentioned nodes may be established.

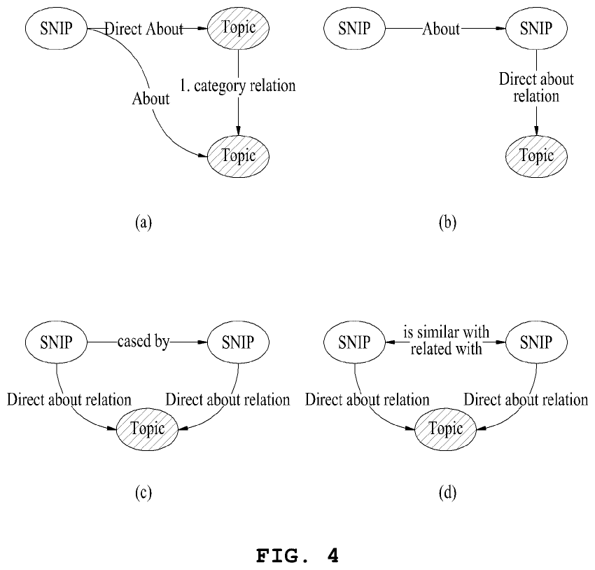

FIG. 4 is a drawing illustrating a relation between a topic and a snip and between snips.

FIG. 4a illustrates a relation to when a new snip is generated at topics. “direct about” may mean that the corresponding topic is directly mentioned. “about” may indicate a direct relation between an upper topic of the topic and the snip. “about” may refer to a relation between the upper topic of the corresponding topic and the snip.

FIG. 4b indicates a relation between snips. “about” between snips may be regarded as a comment. FIG. 4c illustrates that a series of consecutive posts is represented. “caused by”, “based on”, or “transformed to” may be information capable of being added to an additional explanation of a snip when wanting to indicate continuity over time and may express consecutive posts of a corresponding topic in order of time.

FIG. 4c defines a relation used to manage similar posts. “is similar with” or “related with” may be a relation for indicating similar posts and may be information capable of being added to an additional explanation of a snip.

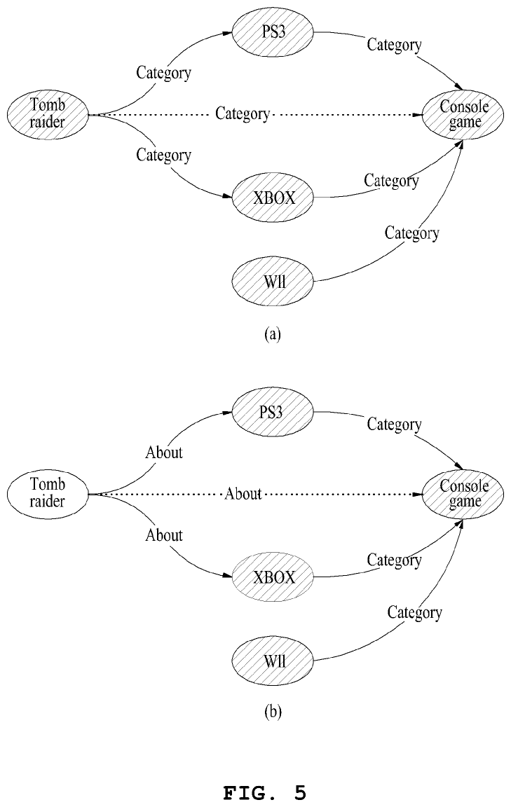

FIG. 5 is a drawing illustrating multi-tagging.

FIG. 5a is a drawing illustrating multi-tagging of a topic and illustrates that, while a Tomb Raider topic is generated, the Tomb Raider topic is multi-tagged to a PS2 topic and an XBOX topic. Because the Tomb Raider topic is multi-tagged to the PS3 and XBOX topics, information of the Tomb Raider topic may be exposed at the PS3 and XBOX topics and may also be exposed at a console game topic which is an upper node of the PS3 and XBOX topics.

FIG. 5b is a drawing illustrating multi-tagging of a snip and illustrates that, while a Tomb Raider snip is generated, the Tomb Raider snip is multi-tagged to the PS3 topic and the XBOX topic. Because the Tomb Raider snip is multi-tagged to the PS3 and XBOX topics, the Tomb Raider snip may be exposed at the PS3 and XBOX topics and may also be exposed at a console game topic which is an upper node of the PS3 and

XBOX topics.

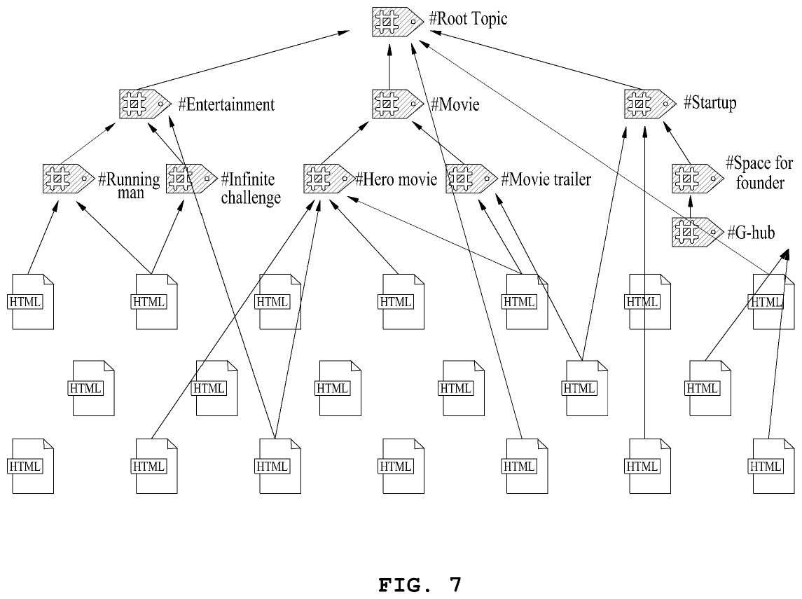

The topic network service according to an embodiment of the inventive concept may perform grouping for each topic and may expose information exposed at a lower node at an upper node having a defined connection relation with the corresponding node to expose the corresponding information at the upper node as well as the topic node at which the corresponding information is generated. For example, in a topic network service based on a tree structure of hashtags shown in FIG. 7, a root topic may expose all information (HTML) exposed at a lower topic such as an entertainment topic, a movie topic, or a startup topic. The entertainment topic may expose all information exposed at a Running Man topic and an Infinite Challenge topic which are lower topics, each of which has a defined connection relation. Of course, for a topic of which spread function is off, information of the corresponding topic may fail to be exposed at an upper topic.

As described above, because of using a tree structure based on a hashtag, the method according to the inventive concept may facilitate multi-tagging using the hashtag. Because a snip tagged to a lower topic is exposed at an upper topic having a defined connection relation with the lower topic, the method may verify information of the lower topic at all related topics. Furthermore, because of having a tree structure based on a hashtag, the method according to the inventive concept may manage the flow of information as the tree structure.

The topic network service method according to the inventive concept may expose information included in a corresponding node at an upper node having a defined connection relation with the corresponding node, based on a relation between topics, a relation between a topic and a snip, or a defined relation when a connection relation is defined.

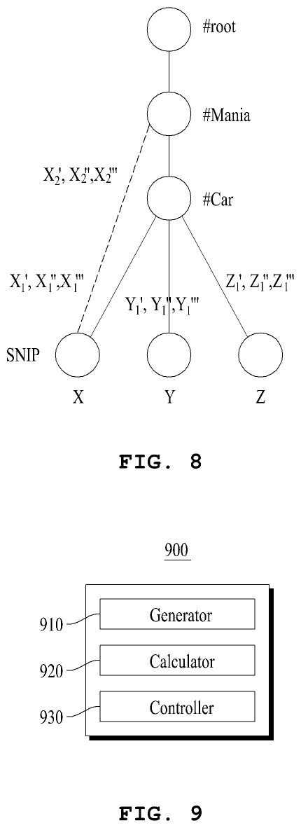

FIG. 9 is a drawing illustrating a configuration of a service system for a topic network according to an embodiment of the inventive concept and illustrates a configuration of a system which performs operations of FIGS. 1 to 8.

Referring to FIG. 9, a service system 900 for a topic network according to an embodiment of the inventive concept may include a generator 910, a calculator 920, and a controller 930.

The generator 910 may generate first information at a topic node at which a user wants to generate information, for example, a first node of a topic network, based on a user input.

Herein, the generator 910 may generate a topic in the topic network and may generate a snip in a topic.

In detail, as a relation between nodes is defined through tagging of respective nodes generated in the topic network, the generator 910 may generate a topic in the topic network and may generate a snip in a topic.

The calculator 920 may calculate a ranking score of each of information in consideration of popularity for each of the information, a current time, and a time when each of the information is generated, with respect to the information exposed at each node of the topic network.

At this time, the calculator 920 may calculate popularity or a unique score for each of the information based on upvoting, downvoting, a follower, a comment, an evaluation score, or the like by other users. An upper node having a connection relation with lower nodes may reflect a value obtained by adding all of unique scores of the lower nodes to calculate a score of the corresponding node.

In addition, the calculator 920 may reflect a weight differently set for example, a time decay parameter differently set, for each of a plurality of predetermined ranking algorithms, to calculate a ranking score of each of information in each of the plurality of ranking algorithms.

The controller 930 may control the information generated by the generator 910 to be exposed at an upper node having a defined connection relation with a node where the corresponding information is generated.

Of course, the controller 930 may determine whether a spread function of the corresponding node is enabled. Only when the spread function is enabled, the controller 930 may expose information of the corresponding node at the upper node.

For example, when the spread function is set to expose information by the generator 910, that is, a corresponding snip when the snip is generated, at the upper node by a user, the controller 930 may control the corresponding snip to be exposed at the upper node having a defined connection relation with the corresponding node. When the spread function is set to expose information included in the corresponding node at the upper node with respect to the corresponding node, the controller 930 may control the information included in the corresponding node to be exposed at the upper node having the defined connection relation with the corresponding node. Of course, when it is unable to set the spread function when a snip is generated, exposing at the upper node may be determined according to whether the spread function of the topic node at which the corresponding snip is generated is enabled.

Furthermore, when a specific topic or a specific snip is tagged to a plurality of upper nodes, the controller 930 may control information included in the specific topic or the specific snip to be exposed at each of the plurality of upper nodes.

In addition, the controller 930 may define a connection relation between topic nodes based on a correlation between hashtags of each of the optic nodes configuring a topic network to identify an upper node of a specific node and control information of lower nodes to be exposed at the identified upper node.

Of course, although not described with reference to FIG. 9, the system of FIG. 9 may perform all the operations of FIGS. 1 to 8 and may include all the details of FIGS. 1 to 8.

The foregoing systems or devices may be realized by hardware elements, software elements and/or combinations thereof. For example, the systems, devices, and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

### MODE FOR INVENTION

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A service method for a topic network based on a hashtag having a tree structure, the method comprising:
generating first information at a first node of the topic network based on a user input; and
exposing the first information, generated at the first node, at an upper node having a defined connection relation with the first node.

2. The method of claim 1, wherein the exposing at the upper node comprises:
when the exposing at the upper node is set by a user when the first information is generated, exposing the first information at an upper node of the first node.

3. The method of claim 1, wherein the exposing at the upper node comprises:
when the exposing at the upper node is preset with respect to the first node, exposing the first information at an upper node of the first node.

4. The method of claim 1, wherein the exposing at the upper node comprises:
when the first node is tagged to a plurality of upper nodes, exposing the first information at each of the plurality of upper nodes.

5. The method of claim 1, further comprising:
calculating a ranking score of each of information in consideration of popularity including at least one of upvoting, downvoting, a follower, a comment, or an evaluation score by others, a time when each of exposed information is generated, and a current time, with respect to the information exposed at each node of the topic network.

6. The method of claim 5, wherein the calculating of the ranking score comprises:
calculating the ranking score of each of the information in each of the plurality of ranking algorithms by reflecting a weight differently set for each of a plurality of predetermined ranking algorithms in at least one of the popularity or a difference between the current time and the time when each of the exposed information is generated.

7. The method of claim 1, wherein the exposing at the upper node comprises:
identifying an upper node having a defined connection relation with the first node, based on a correction between a hashtag of the first node or the first information and a hashtag of each node of the topic network having the tree structure; and
exposing the first information at the identified upper node.

8. A service method for a topic network based on a hashtag having a tree structure, the method comprising:
defining a relation between a first node in the topic network and first information to be generated, based on a user input; and
when the relation between the first node and the first information is defined, exposing the first information at an upper node having a defined connection relation with the first node.

9. A service system for a topic network based on a hashtag having a tree structure, the system comprising:
a generator configured to generate first information at a first node of the topic network based on a user input; and
a controller configured to expose the first information, generated at the first node, at an upper node having a defined connection relation with the first node.

10. The system of claim 9, wherein the controller is configured to:
when the exposing at the upper node is set by a user when the first information is generated, expose the first information at an upper node of the first node.

11. The system of claim 9, wherein the controller is configured to:
when the exposing at the upper node is preset with respect to the first node, expose the first information at an upper node of the first node.

12. The system of claim 9, wherein the controller is configured to:
when the first node is tagged to a plurality of upper nodes, expose the first information at each of the plurality of upper nodes.

13. The system of claim 9, further comprising:
a calculator configured to calculate a ranking score of each of information in consideration of popularity including at least one of upvoting, downvoting, a follower, a comment, or an evaluation score by others, a time when each of exposed information is generated, and a current time, with respect to the information exposed at each node of the topic network.

14. The system of claim 13, wherein the calculator is configured to:
calculate the ranking score of each of the information in each of the plurality of ranking algorithms by reflecting a weight differently set for each of a plurality of predetermined ranking algorithms in at least one of the popularity or a difference between the current time and the time when each of the exposed information is generated.

15. The system of claim 9, wherein the controller is configured to:
identify an upper node having a defined connection relation with the first node, based on a correction between a hashtag of the first node or the first information and a hashtag of each node of the topic network having the tree structure; and
expose the first information at the identified upper node.
